(19) United States
(12) Patent Application Publication
(10) Pub. No.: US 2009/0186798 A1
(43) Pub. Date: Jul. 23, 2009

(54) Colour-Care Composition

(76) Inventors: Gail Margaret Baston, Whitley Bay (GB); Smilja Djurdjevic, Newcastle upon Tyne (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/352,652

(22) Filed: Jan. 13, 2009

(30) Foreign Application Priority Data
Jan. 22, 2008 (EP) 08100727.0

(51) Int. Cl. C11D 3/28

(52) U.S. Cl. 510/360; 510/513; 510/276

(57) ABSTRACT

Composition with improved fabric and colour care benefits. The composition comprises dye transfer inhibitor(s) and a silicone. The compositions are suitable for use in laundry treatment processes for improving the colour vibrancy of the fabrics.

### FIELD OF THE INVENTION

The present invention relates to compositions with fabric and colour care benefits. More specifically, the present invention relates to fabric treatment compositions which comprise dye transfer inhibitor(s) and a silicone. The compositions of the present invention are suitable for use in laundry treatment processes for improving the colour vibrancy of fabrics.

### BACKGROUND OF THE INVENTION

It is well known that when a dyed fabric is laundered by current laundry detergent products, one problem which may occur during the washing process is the fading of colour of the fabric with repeated laundering. Detergent ingredients such as bleach, pH and other conditions used in the washing process such as temperature and agitation, may all contribute to this problem. Thus, detergent formulations and conditions of the washing process that are optimal for fabric cleaning may also be detrimental for fabric colour care and cause dyed fabric to fade in colour. To alleviate this problem, detergents specifically formulated to provide improved fabric colour care benefits are known. Typically these detergents are bleach-free and some comprise detergent ingredients which help keep the dye bound to the surface of the coloured fabric during the washing process. However, after undergoing repeated washing cycles using these detergents, colour fading from the dyed fabric may still be a problem. However, there is still a need for detergents that provide effective colour-care benefits in addition to good cleaning, particularly after multi-cycle laundering.

The Inventors have surprisingly found that by adding a dye transfer inhibitor, a silicone and a clay to a composition, highly effective colour vibrancy of the fabrics can be obtained, with a reduction of colour fading during the washing process, even when washed repeatedly.

Dye transfer inhibitors are known for their use in laundry compositions as anti-redeposition agents. Dye transfer inhibitors scavenge the free dye molecules from the wash water, thus suspending the dyes and preventing them from redepositing onto the fabric. Due to their high affinity for dyes, dye transfer inhibitors may also remove dyes from the fabric and therefore diminish the colour vibrancy of the fabric. Accordingly it is very surprising that dye transfer inhibitors could be used for a completely opposite purpose which is enhancing the colour vibrancy of the fabric.

### SUMMARY OF THE INVENTION

In one embodiment of the present invention, a colour care composition is provided which comprises a dye transfer inhibitor, a silicone, and a clay.

Typically the composition is for fabric treatment, particularly the composition is a detergent composition.

In particular, the composition comprises particles comprising clay and silicone.

The inventors have found that the compositions according to the invention not only improve the colour vibrancy of the fabric but also provide softness benefits. The compositions of the invention also give good whiteness results.

According to a further embodiment, the present invention concerns the use of a dye transfer inhibitor to prepare a composition for enhancing the colour vibrancy of a fabric.

In the meaning of the invention, colour vibrancy is to be understood as high intensity of colour. More colour vibrancy may be understood as less colour fading.

According to a further embodiment, the invention also relates to the use of a dye transfer inhibitor to enhance the colour vibrancy of a fabric. In particular the invention relates to the use of a dye transfer inhibitor and a clay to enhance the colour vibrancy of a fabric. According to another aspect of the invention, the invention concerns the use of a dye transfer inhibitor and a silicone to enhance the colour vibrancy of a fabric.

The invention is also related, to a process for enhancing the colour vibrancy of a fabric comprising the steps of:
introducing a composition according to the invention into water to form a fabric treatment solution,
contacting the fabric with said fabric treatment solution.

The steps may be executed in any order.

In particular, the composition may be introduced into the water in such an amount that the B:H ratio is from 0 to 0.8. The B:H ratio is the molar ratio of builder capacity to hardness.

When not specified, the percentages are percentages by weight.

### DETAILED DESCRIPTION OF THE INVENTION

### Dye Transfer Inhibitor

The composition of the present invention contains an effective amount of dye transfer inhibitor (DTI) or mixtures thereof.

An effective amount of DTI is typically an amount which will provide at least about 0.1 ppm, preferably from about 0.1 ppm to about 2,000 ppm, more preferably from about 0.2 ppm to about 1,000 ppm, in the wash or rinse solution. Preferably, the composition of the present invention contains from 0.01% to 30%, in particular from 0.03% to 10% by weight of dye transfer inhibitor, more preferably from about 0.05% to about 5%, and even more preferably from about 0.1% to about 2%, or from 0.2 or even 0.4% to about 1% by weight.

Preferred dye transfer inhibitors are polymers preferably selected from the group consisting of polymers which are water-soluble and able to bind to a dye, and mixtures thereof. In particular, the DTI is a polymer containing nitrogen and oxygen atoms. The DTI is not an enzyme.

Typically, dye transfer inhibitors useful in the present invention include water-soluble polymers containing nitrogen and oxygen atoms, selected from the group consisting of:

(A) polymers, comprising one or more monomeric units containing at least one N—C(═O)— group, wherein the nitrogen is additionally bonded to either one or two other atoms (i.e., can additionally have two single bonds or one double bond);

(B) polymers comprising one or more monomeric units containing at least one N-oxide group;

(C) polymers comprising both one or more monomeric units containing N—C(═O)— group of (A), wherein the nitrogen is additionally bonded to either one or two other atoms and one or more monomeric units containing N-oxide groups of (B);

(D) mixtures thereof;

Dye transfer inhibitors useful in the present invention include water-soluble polymers having the structure:

—[P(D)ₘ]ₙ-

wherein each P is selected from homopolymerizable and copolymerizable moieties which attach to form the polymer backbone, preferably each P being selected from the group consisting of: vinyl moieties, e.g., [—C(R)₂—C(R)₂—]; other monomeric moieties, e.g., [[C(R)₂]ₓ-L-], wherein each x is an integer from 1 to 6 and each L is independently selected from the group consisting of:

—N(R)—; —O—; —S—; —O—C(═O)—; —C(═O)—O—; —S(═O)—; —S(—O)₂—; —S(—O)—O—; —O—S(═O)—; —O—S(═O)₂—O—; —O—[—Si(R₂)—O—]ₚ—; —C(═O)—; and —O—C(═O)—O—; and DTI-active groups —N(—O)(R)—; —N(R)C(═O)—; —C(═O)—N(R)—.

wherein each R is H, C₁₋₁₂ (preferably C₁₋₄) alkyl(ene), C₆-C₁₂ aryl(ene) and/or D, m is from 0 to 2, and p is from 1 to about 6; wherein each D contain moieties selected from the group consisting of: L moieties; structural moieties selected from the group consisting of linear and cyclic C₁₋₁₂ (preferably C₁₋₄) alkyl; C₁₋₁₂ alkylene; C₁₋₁₂ heterocyclic groups, which can also contain the DTI active groups; aromatic C₆₋₁₂ groups; and Rs to complete the group, wherein any linking groups which are attached to each other form linkages that are substantially stable under conditions of use; and wherein the nitrogen atoms can be attached to one, two, or three other atoms, the number of N—C(═O)— and/or N-Oxide groups present being sufficient to provide dye transfer inhibition, the total molecular weight being from about 500 to about 1,000,000, preferably from about 1,000 to about 500,000, n being selected to provide the indicated molecular weight, and the water solubility being at least about 100 ppm, preferably at least about 300 ppm, and more preferably at least about 1,000 ppm in water at ambient temperature of about 25° C.

A. Polymers with Active N—C(═O)— Groups

One useful group of polymeric DTIs include water-soluble polymers containing active N—C(═O)— groups, excluding enzymes. The nitrogen of the N—C(═O)— group can be bonded to either one or two other atoms.

Examples of polymers containing N—C(═O)— groups are:

Polyvinylpyrrolidone:

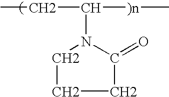

Polyvinyloxazolidone:

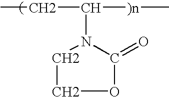

Polyvinylmethyloxazolidone:

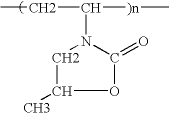

Polyacrylamide and N-substituted polyacrylamides:

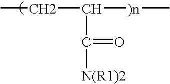

wherein each R1 is independently selected from H and C₁₋₆ alkyl groups, e.g., methyl, ethyl, propyl, or isopropyl, or two R1 groups can form a 5 or 6 member ring structure.

Polymethacrylamide and N-substituted polymethacrylamides:

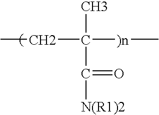

Poly(N-acrylylglycinamide):

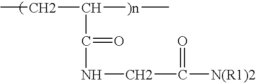

Poly(N-methacrylylglycinamide):

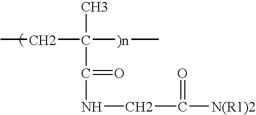

Poly(2-ethyl-2-oxazoline):

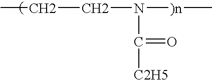

Polyvinylurethane:

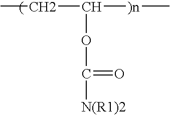

wherein each R1 is as described above. Mixtures of these groups can be present in the polymeric DTI groups of (A) and (C) described hereinbefore and hereinafter.

These polymers have an amphiphilic character with polar groups conferring hydrophilic properties and apolar groups conferring hydrophobic properties. Preferred polymers are those having the nitrogen atoms highly substituted so that they are shielded to different degrees by the surrounding apolar groups.

Examples of said polymers are polyvinylpyrrolidones (PVP), polyvinyloxazolidones, N,N-disubstituted polyacrylamides, and N,N-disubstituted polymethacrylamides. Detailed description of physicochemical properties of some of these polymers are given in “Water-Soluble Synthetic Polymers: Properties and Behavior,” Vol. 1, Philip Molyneux, CRC Press, 1983.

These polymers are also useful in the present invention in partially hydrolyzed and/or crosslinked forms.

A preferred dye transfer inhibitor is polyvinylpyrrolidone (PVP). This polymer has an amphiphilic character with a highly polar amide group, conferring hydrophilic and polar-attracting properties, and also has apolar methylene and methine groups, in the backbone and/or the ring, conferring hydrophobic properties.

The rings may also provide planar alignment with the aromatic rings in the dye molecules. PVP is readily soluble in aqueous and organic solvent systems.

PVP is available from ISP, Wayne, N.J., and BASF Corp., Parsippany, N.J., as a powder or aqueous solutions in several viscosity grades, designated as, e.g., K-12, K-15, K-25, and K-30. These K-values indicate the viscosity average molecular weight, as shown below:

| | K-12 | K-15 | K-25 | K-30 |
|---|---|---|---|---|
| PVP Viscosity Avg. Mol. Wt. | 2,500 | 10,000 | 24,000 | 40,000 |

PVP K-12, K-15, and K-30 are also available from Polysciences, Inc. Warrington, Pa., and PVP K-15, K-25, and K-30 and poly(2-ethyl-2-oxazoline) are available from Aldrich Chemical Co., Inc., Milwaukee, Wis.

The average molecular weight for water-soluble polymers with N—C(═O)— groups useful in the present invention is typically from about 500 to about 100,000, preferably from about 500 to about 40,000, and more preferably from about 1,000 to about 30,000.

B. Polymers with Active N-Oxide Groups

Another useful group of polymeric DTI includes water-soluble polymers containing active N-Oxide groups. The nitrogen of the N-Oxide group can be bonded to either one, two, or three other atoms.

One or more of the N-Oxide groups can be part of the pendant D group or one or more N-Oxide groups can be part of the polymerizable P unit or a combination of both.

Where the N-Oxide group is part of the pendant D group, preferred D groups contain cyclic structures with the nitrogen atom of the N-Oxide group being part of the ring or outside the ring. The ring in the D group may be saturated, unsaturated, or aromatic.

Examples of D groups containing the nitrogen atom of the N-Oxide group include N-oxides of heterocyclic compounds such as the N-oxides of pyridine, pyrrole, imidazole, pyrazole, pyrazine, pyrimidine, pyridazine, piperidine, pyrrolidone, azolidine, morpholine, and derivatives thereof. A preferred dye transfer inhibitor is poly(4-vinylpyridine N-oxide) (PVNO). Examples of D groups with the nitrogen atom of the N-Oxide group being outside the ring include aniline oxide and N-substituted aniline oxides.

An example of a polymer wherein the N-Oxide group is part of the monomeric P backbone group is polyethyleneimine N-oxide.

Mixtures of these groups can be present in the polymeric DTIs of (B) and (C).

The amine N-oxide polymers of the present invention typically have a ratio of amine N-oxide to the amine of from about 1:0 to about 1:2. The amount of amine oxide groups present in the polyamine oxide polymer can be varied by appropriate copolymerization or by appropriate degree of N-oxidation. Preferably, the ratio of amine N-oxide to amine is from about 1:0 to about 1:1, most preferred from 1:0 to about 3:1.

The amine oxide unit of the polyamine N-oxides has a PKa≦10, preferably PKa≦7, more preferably PKa≦6.

The average molecular weight of (B) useful in the present invention is from about 500 to about 1,000,000; more preferably from about 1,000 to about 500,000; most preferably from about 2,000 to about 100,000.

Any polymer backbone above can be used in (A) or (B) as long as the polymer formed is water soluble and has dye transfer inhibiting properties. Examples of suitable polymeric backbones are polyvinyls, polyalkylenes, polyesters, polyethers, polyamide, polyimides, polyacrylates, and copolymers and block copolymers thereof, and mixtures thereof.

C. Copolymers Including Active N—C(═O)— and/or N-Oxide Groups

Effective polymeric DTI agents can include those formed by copolymerizing mixtures of monomeric, oligomeric, and/or polymeric units containing active N—C(═O)— and/or active N-Oxide groups (e.g., copolymers and/or block copolymers of PVP and PVNO). Other suitable DTI copolymers include those in which an effective amount of monomeric, oligomeric, and/or polymeric units containing active N—C(═O)— groups and/or active N-Oxide groups is copolymerized with “filler” monomeric, oligomeric, and/or polymeric units which do not contain active N—C(═O)— or N-Oxide groups but which impart other desirable properties to the DTI copolymer, such as increased water solubility or enhanced fabric substantivity [e.g., block copolymer of PVP (about 60%) and polyvinylimidazole (PVPVI)].

Preferred DTI are chosen among polyvinylpyrrolidone (PVP), poly(4-vinylpyridine N-oxide) (PVNO), and copolymers of PVP and polyvimyilimidazole (PVPVI) and mixtures thereof.

The average molecular weight of the polymeric DTI useful in the present invention is from 500 to 1,000,000; more preferably from 1,000 to 500,000; most preferably from 2,000 to 100,000.

### The Silicone

The composition of the present invention may contain at least 0.03 or even at least 0.1% by weight of silicone. The composition may comprise from 0.3% to 30% by weight of silicone, in particular from 0.4% to 10%, and even from 1% to 5% or from 1.1% to 4.9%.

When present in the composition, the silicone is preferably a fabric-softening silicone. Suitable silicones have the general formula:

A-[Si(R₁)(R₂)−O—]ₓ-A

wherein, each R₁ and R₂ in each repeating unit, —(Si(R₁)(R₂)O)—, may be independently selected from branched or unbranched, substituted or unsubstituted C₁-C₁₀ alkyl or alkenyl, substituted or unsubstituted phenyl, or units of —[—R₁R₂Si—O—]—. x may be a number from 50 to 300,000, preferably from 100 to 100,000, more preferably from 200 to 50,000. The substituted alkyl, alkenyl or phenyl may be typically substituted with halogen, amino, hydroxyl groups, quaternary ammonium groups, polyalkoxy groups, carboxyl groups, or nitro groups. Each A group may be independently selected from the group consisting of a hydroxyl group, hydrogen or —SiR₃, wherein, R₃ is hydrogen or a functional group such as hydroxyl or alkyl and is preferably methyl.

Suitable silicones include: amino-silicones, such as those described in EP 150872, WO 92/01773 and U.S. Pat. No. 4,800,026; quaternary-silicones, such as those described in U.S. Pat. No. 4,448,810 and EP 459821; high-viscosity silicones, such as those described in WO 00/71806 and WO 00/71807; modified polydimethylsiloxane; functionalized polydimethyl siloxane such as those described in U.S. Pat. No. 5,668,102. Preferably, the silicone is a polydimethylsiloxane.

The silicone may preferably be a silicone mixture of two or more different types of silicone. Preferred silicone mixtures are those comprising: a high-viscosity silicone and a low viscosity silicone; a functionalised silicone and a non-functionalised silicone; or a non-charged silicone polymer and a cationic silicone polymer.

The silicone typically has a viscosity, of from 5,000 cp to 5,000,000 cp, or from greater than 10,000 cp to 1,000,000 cp, or from 10,000 cp to 600,000 cp, more preferably from 50,000 cp to 400,000 cp, and more preferably from 80,000 cp to 200,000 cp when measured at a shear rate of 20^{s-1} and at ambient conditions (20° C. and 1 atmosphere). The silicone is typically in a liquid or liquefiable form, especially when admixed with the clay. Typically, the silicone is a polymeric silicone comprising more than 3, preferably more than 5 or even more than 10 siloxane monomer units.

The silicone is preferably loaded on an inorganic carrier, such as clay.

Preferably, in the composition, the weight ratio of the silicone to the polymeric dye transfer inhibitor, is from 1:10 to 100:1, preferably from 1:3 to 30:1, more preferably from 1:1 to 10:1 or even of about 3:1.

### The Clay

The composition of the present invention may contain at least 0.3 or even at least 1% by weight of clay. The composition may comprise from 2% to 30%, more preferably from 3% to 10% by weight of clay.

Typically, the clay is a fabric-softening clay such as a smectite clay. Preferred smectite clays are beidellite clays, hectorite clays, laponite clays, montmorillonite clays, nontonite clays, saponite clays and mixtures thereof. Preferably, the smectite clay is a dioctahedral smectite clay, more preferably a montmorillonite clay. Dioctrahedral smectite clays typically have one of the following two general formulae:

NaₓAl₂₋ₓMgₓSi₄O₁₀(OH)₂ Formula (I)

or

CaₓAl₂₋ₓMgₓSi₄O₁₀(OH)₂ Formula (II)

wherein x is a number from 0.1 to 0.5, preferably from 0.2 to 0.4.

Preferred clays are low charge montmorillonite clays (also known as a sodium montmorillonite clay or Wyoming type montmorillonite clay) which have a general formula corresponding to formula (I) above. Preferred clays are also high charge montmorillonite clays (also known as a calcium montmorillonite clay or Cheto type montmorillonite clay) which have a general formula corresponding to formula (II) above. Preferred clays are supplied under the tradenames: Fulasoft 1 by Arcillas Activadas Andinas; White Bentonite STP by Fordamin; and Detercal P7 by Laviosa Chemica Mineraria SPA.

The clay may be a hectorite clay. Typical hectorite clay has the general formula:

[(Mg₃₋ₓLiₓ)Si_{4-y}Me^{III}_{y}O₁₀(OH_{2-z}F_{z})]^{-(x+y)}((x+y)/n)Mⁿ⁺ Formula (III)

wherein y=0 to 0.4, if y>0 then MeIII is Al, Fe or B, preferably y=0; Mn+ is a monovalent (n=1) or a divalent (n=2) metal ion, preferably selected from Na, K, Mg, Ca and Sr. x is a number from 0.1 to 0.5, preferably from 0.2 to 0.4, more preferably from 0.25 to 0.35. z is a number from 0 to 2. The value of (x+y) is the layer charge of the clay, preferably the value of (x+y) is in the range of from 0.1 to 0.5, preferably from 0.2 to 0.4, more preferably from 0.25 to 0.35. A preferred hectorite clay is that supplied by Rheox under the tradename Bentone HC. Other preferred hectorite clays for use herein are those hectorite clays supplied by AMCOL Materials under the tradename Hectorite U and Hectorite R, respectively.

The clay may also be selected from the group consisting of: allophane clays; chlorite clays, preferred chlorite clays are amesite clays, baileychlore clays, chamosite clays, clinochlore clays, cookeite clays, corundophite clays, daphnite clays, delessite clays, gonyerite clays, nimite clays, odinite clays, orthochamosite clays, pannantite clays, penninite clays, rhipidolite clays, sudoite clays and thuringite clays; illite clays; inter-stratified clays; iron oxyhydroxide clays, preferred iron oxyhydoxide clays are hematite clays, goethite clays, lepidocrite clays and ferrihydrite clays; kaolin clays, preferred kaolin clays are kaolinite clays, halloysite clays, dickite clays, nacrite clays and hisingerite clays; smectite clays; vermiculite clays; and mixtures thereof.

The clay may also be a light coloured crystalline clay mineral, preferably having a reflectance of at least 60, more preferably at least 70, or at least 80 at a wavelength of 460 nm. Preferred light coloured crystalline clay minerals are china clays, halloysite clays, dioctahedral clays such as kaolinite, trioctahedral clays such as antigorite and amesite, smectite and hormite clays such as bentonite (montmorillonite), beidilite, nontronite, hectorite, attapulgite, pimelite, mica, muscovite and vermiculite clays, as well as pyrophyllite/talc, willemseite and minnesotaite clays. Preferred light coloured crystalline clay minerals are described in GB 2357523A and WO 01/44425.

Preferred clays have a cationic exchange capacity of at least 70 meq/100 g. The cationic exchange capacity of clays can be measured using the method described in Grimshaw, The Chemistry and Physics of Clays, Interscience Publishers, Inc., pp. 264-265 (1971).

Preferably, the clay has a weight average primary particle size, typically of from 0.1 micrometers to 50 micrometers, more preferably from 5 micrometers to 30 micrometers. Clays having these preferred weight average primary particle sizes provide a further improved fabric-softening benefit. The method for determining the weight average particle size of the clay is described in EP 1 561 806.

Preferably, the weight ratio of silicone to clay is from 3:1 to 1:30, for example from 1:1 to 1:10.

Preferably, in the composition, the weight ratio of the clay to the polymeric dye transfer inhibitor, is from 1:3 to 300:1, preferably from 1:1 to 100:1, more preferably from 3:1 to 30:1 or even of about 10:1.

### Particles Comprising Clay and Silicone

According to one preferred embodiment of the invention, the composition comprises particles comprising clay and silicone.

In order to produce a particle comprising clay and silicone, the silicone is preferably in the form of an emulsion prior to admixing with clay. The emulsion can be a water-in-oil emulsion or an oil-in-water emulsion. The emulsion is preferably in the form of a water-in-oil emulsion with the silicone forming at least part, and preferably all, of the continuous phase, and the water forming at least part, and preferably all, of the discontinuous phase. The emulsion typically has a volume average primary droplet size of from 0.1 micrometers to 5,000 micrometers, preferably from 0.1 micrometers to 50 micrometers, and most preferably from 0.1 micrometers to 5 micrometers. The volume average primary particle size is typically measured using a Coulter Multisizer™ or by the method described in EP 1 561 806.

Preferably, in the emulsion, the weight ratio of the silicone to emulsifier, if present, is from 3:1 to 20:1.

The silicone in emulsified form typically has a viscosity of from 500 cp to 70,000 cp, or from 3,000 cp to 20,000 cp.

Commercially available silicone oils that are suitable for use are DC200™ (12,500 cp to 600,000 cp), supplied by Dow Coming, or silicones of the Baysilone Fluid M series supplied by GE Silicone. Alternatively, preformed silicone emulsions are also suitable for use. These emulsions may comprise water and/or other solvents in an effective amount to aid the emulsification of the silicone.

The particles comprising clay and silicone may be obtained either by intimately mixing clay and a silicone or according to a process comprising the steps of (i) contacting a silicone with water, and optionally an emulsifier, to form a silicone in an emulsified form; and (ii) thereafter contacting the silicone in an emulsified form with clay to form an admix of clay and a silicone. Preferably the silicone is in a liquid or liquefiable form when it is contacted to the clay in step (ii).

Step (i) may be carried out at ambient temperature (e.g. 20° C.), but it may be preferred that step (i) is carried out at elevated temperature such as a temperature in the range of from 30° C. to 60° C. If an emulsifier is used in the process, then preferably the emulsifier is contacted to water to form an emulsifier-water mixture, thereafter the emulsifier-water mixture is contacted to the silicone. For continuous processes, step (i) is typically carried out in an in-line static mixer or an in-line dynamic (shear) mixer. For non-continuous processes, step (i) is typically carried out in a batch mixer such as a Z-blade mixer, anchor mixer or a paddle mixer.

The admix of clay and silicone is preferably subsequently agglomerated in a high-sheer mixer. Suitable high-sheer mixers include CB Loedige mixers, Schugi mixers, Littleford mixers, Drais mixers and lab scale mixers such as Braun mixers. Preferably the high-sheer mixer is a pin mixer such as a CB Loedige mixer or Littleford mixer or Drais mixer. The high-sheer mixers are typically operated at high speed, preferably having a tip speed of from 30 ms⁻¹ to 35 ms⁻¹. Preferably water is added to the high-sheer mixer.

The admix of clay and silicone are typically subsequently subjected to a conditioning step in a low-shear mixer. Suitable low-shear mixers include Ploughshear mixers such as a Loedige KM. Preferably the low-shear mixer has a tip speed of from 5 ms⁻¹ to 10 ms⁻¹. Optionally, fine particles such as zeolite and/or clay particles, typically having an average particle size of from 1 micrometer to 40 micrometers or even from 1 micrometer to 10 micrometers are introduced into the low-shear mixer. This dusting step improves the flowability of the resultant particles by reducing their stickiness and controlling their growth.

The admix of clay and silicone is typically subjected to a sizing step, wherein particles having a particle size of greater than 500 mm are removed from the admix. Typically, these large particles are removed from the admix by sieving.

The admix of clay and silicone is preferably subjected to hot air having a temperature of greater than 50° C. or even greater than 100° C. Typically, the admix of clay and silicone is dried at an elevated temperature (e.g. a temperature of greater than 50° C. or even greater than 100° C.); preferably, the admix is dried in a low-shear apparatus such as fluid bed drier. Following this preferred drying step, the admix of clay and silicone is preferably thereafter subjected to cold air having a temperature of less than 15° C., preferably from 1° C. to 10° C. This cooling step is preferably carried out in a fluid bed cooler.

The admix of clay and silicone is preferably subjected to a second sizing step, wherein particles having a particle size of less than 250 micrometers are removed from the admix. These small particles are removed from the admix by sieving and/or elutriation. If elutriation is used, then preferably the second sizing step is carried out in a fluid bed such as the fluid bed dryer and/or cooler, if used in the process.

The admix of clay and silicone is preferably subjected to a third sizing step, wherein particles having a particle size of greater than 1,400 micrometers are removed from the admix. These large particles are removed from the admix by sieving.

The large particles that are optionally removed from the admix during the first and/or third sizing steps are typically recycled back to the high sheer mixer and/or to the fluid bed dryer or cooler, if used in the process. Optionally, these large particles are subjected to a grinding step prior to their introduction to the high sheer mixer and/or fluid bed dryer or cooler. The small particles that are optionally removed from the admix during the second sizing step are typically recycled back to the high sheer mixer and/or low shear mixer, if used in the process.

The clay and silicone particles may comprise at least 20%, preferably at least 40%, or even at least 60% and in particular at least 80% by weight of silicone and clay.

Examples of particles of clay/silicone admix are disclosed in EP 1 561 806.

### Adjunct

While not essential for the purposes of the present invention, the non-limiting list of adjuncts illustrated hereinafter are suitable for use in the instant compositions and may be desirably incorporated in certain embodiments of the invention. The precise nature of these additional adjunct components, and levels of incorporation thereof, will depend on the physical form of the composition and the nature of the cleaning operation for which it is to be used. Suitable adjunct materials include, but are not limited to, surfactants, builders, flocculating aid, chelating agents, additional dye transfer inhibitors, enzymes and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, solvents and/or pigments. In addition to the disclosure below, suitable examples of such other adjuncts and levels of use are found in U.S. Pat. Nos. 5,576,282, 6,306,812 B1 and 6,326,348 B1 that are incorporated by reference. When one or more adjuncts are present, such one or more adjuncts may be present as detailed below:

SURFACTANT—The compositions according to the present invention may comprise a surfactant or surfactant system. The compositions may comprise from 0.01% to 90%, or from 5 to 10%, by weight of a surfactant system. The surfactant may be selected from nonionic surfactants, anionic surfactants, cationic surfactants, ampholytic surfactants, zwitterionic surfactants, semi-polar nonionic surfactants and mixtures thereof.

Anionic Surfactants

Typically, the detergent composition comprises from 1 to 50 wt % anionic surfactant, more typically from 2 to 40 wt %.

Suitable anionic surfactants typically comprise one or more moieties selected from the group consisting of carbonate, phosphate, phosphonate, sulphate, sulphonate, carboxylate and mixtures thereof. The anionic surfactant may be one or mixtures of more than one of C₈₋₁₈ alkyl sulphates and C₈₋₁₈ alkyl sulphonates, linear or branched, optionally condensed with from 1 to 9 moles of C₁₋₄ alkylene oxide per mole of C₈₋₁₈ alkyl sulphate and/or C₈₋₁₈ alkyl sulphonate.

Preferred anionic detersive surfactants are selected from the group consisting of: linear or branched, substituted or unsubstituted, C₁₂₋₁₈ alkyl sulphates; linear or branched, substituted or unsubstituted, C₁₀₋₁₃ alkylbenzene sulphonates, preferably linear C₁₀₋₁₃ alkylbenzene sulphonates; and mixtures thereof. Highly preferred are linear C₁₀₋₁₃ alkylbenzene sulphonates. Highly preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

Alkoxylated Anionic Surfactants

The composition may comprise an alkoxylated anionic surfactant. When present alkoxylated anionic surfactant will generally be present in amounts form 0.1 wt % to 40 wt %, for example from 1 wt % to 3wt % based on the detergent composition as a whole.

Preferably, the alkoxylated anionic detersive surfactant is a linear or branched, substituted or unsubstituted C₁₂₋₁₈ alkyl alkoxylated sulphate having an average degree of alkoxylation of from 1 to 30, preferably from 3 to 7.

Suitable alkoxylated anionic detersive surfactants are: Texapan LESTTM by Cognis; Cosmacol AESTM by Sasol; BES151TM by Stephan; Empicol ESC70/UTM; and mixtures thereof.

Non-Ionic Detersive Surfactant

The compositions of the invention may comprise non-ionic surfactant. Where present the non-ionic detersive surfactant(s) is generally present in amounts of from 0.5 to 20 wt %, or from 2 wt % to 4 wt %.

The non-ionic detersive surfactant can be selected from the group consisting of: alkyl polyglucoside and/or an alkyl alkoxylated alcohol; C₁₂-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEx, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

Cationic Detersive Surfactant

In one aspect of the invention, the detergent compositions are free of cationic surfactant. However, the composition optionally may comprise a cationic detersive surfactant. When present, preferably the composition comprises from 0.1 wt % to 10 wt %, or from 1 wt % to 2 wt % cationic detersive surfactant.

Suitable cationic detersive surfactants are alkyl pyridinium compounds, alkyl quaternary ammonium compounds, alkyl quaternary phosphonium compounds, and alkyl ternary sulphonium compounds. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium surfactants as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof.

Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride. Cationic surfactants such as Praepagen HY (tradename Clariant) may be useful and may also be useful as a suds booster.

BUILDER—The builder may comprise a water-insoluble or partially water-soluble builder, a water-soluble builder, or a combination thereof.

Water-Insoluble or Partially Water-Soluble Builder

The composition herein may comprise water-insoluble or partially water-soluble builder. Examples of largely water insoluble builders include the sodium aluminosilicates. Suitable aluminosilicate zeolites have the unit cell formula

Na_{z}[(AlO₂)_{z}(SiO₂)_{y}].xH₂O

wherein z and y are at least 6; the molar ratio of z to y is from 1.0 to 0.5 and x is at least 5, preferably from 7.5 to 276, more preferably from 10 to 264.

The aluminosilicate material is in hydrated form and is preferably crystalline, containing from 10% to 28%, more preferably from 18% to 22% water by weight in bound form. The aluminosilicate zeolites can be naturally occurring materials, but are preferably synthetically derived. Synthetic crystalline aluminosilicate ion exchange materials are available under the designations Zeolite A, Zeolite B, Zeolite P, Zeolite X, Zeolite HS and mixtures thereof Zeolite A has the formula:

Na₁₂[(AlO₂)₁₂(SiO₂)₁₂].xH₂O

wherein x is from 20 to 30, especially 27. Zeolite X has the formula:

Na₈₆[(AlO₂)₈₆(SiO₂)₁₀₆].276H₂O

Preferred crystalline layered silicates for use herein have the general formula:

NaMSiₓO₂ₓ+1.yH₂O

wherein M is sodium or hydrogen, x is a number from 1.9 to 4 and y is a number from 0 to 20.

Crystalline layered sodium silicates of this type are disclosed in EP-A-0164514 and methods for their preparation are disclosed in DE-A-3417649 and DE-A-3742043. Herein, x in the general formula above preferably has a value of 2, 3 or 4 and is preferably 2. The most preferred material is δ— Na₂Si₂0₅, available from Hoechst AG as NaSKS-6.

Water-Soluble Builder

The composition herein may comprise a water-soluble builder. Preferably, the water-soluble builder comprises an alkali or alkaline earth metal salt of phosphate. Suitable examples of a water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerisation ranges from about 6 to 21, and salts of phytic acid. The builder may also comprise polycarboxylic acids and salts thereof, preferably citric acid, alkali metal salts thereof, and combinations thereof.

The composition herein may comprise (by weight) from 1% to 40%, more preferably from 3%, or from 5%, or from 8%, to 25%, to 15%, or to 10% builder.

According to one specific embodiment of the invention, the composition comprises at most 5%, for example from 0.1 to 3%, or even from 0.3 to 1% of aluminosilicate(s) such as zeolite. The composition may comprise at most 5%, for example from 0.1 to 3%, or even from 0.3 to 1%, of phosphate builder(s). The composition may comprise at most 5%, for example from 0.1 to 3%, or even from 0.3 to 1%, of aluminosilicate(s) such as zeolite and phosphate builder(s).

The composition may comprise at most 15%, preferably from 3 to 12%, or even from 5 to 10%, of phosphate builder(s), aluminosilicate builder(s), polycarboxylic acid builder(s), and additional silicate builder(s) such as layered silicate builder(s).

The composition may comprise at most 15%, preferably from 3 to 12%, or even from 5 to 10%, of phosphate builder(s), aluminosilicate builder(s), polycarboxylic acid builder(s), additional silicate builder(s), and other material(s) having at a temperature of 25° C. and at a 0.1M ionic strength a calcium binding capacity superior to 50 mg/g and a calcium binding constant higher than 3.50.

It is believed that the colour vibrancy provided by the compositions according to the invention may be further improved when the amount of builder(s) is lower.

FLOCCULATING AID—The composition may further comprise a flocculating aid. Typically, the flocculating aid is polymeric. Preferably the flocculating aid is a polymer comprising monomer units selected from the group consisting of ethylene oxide, acrylamide, acrylic acid and mixtures thereof. Preferably the flocculating aid is a polyethyleneoxide. Typically the flocculating aid has a molecular weight of at least 100,000 Da, preferably from 150,000 Da to 5,000,000 Da and most preferably from 200,000 Da to 700,000 Da. Preferably the composition comprises at least 0.3% by weight of the composition of a flocculating aid.

When present, the weight ratio of clay to flocculating aid in the composition is preferably in the range of from 10:1 to 200:1, preferably from 14:1 to 160:1 more preferably from 20:1 to 100:1 and more preferably from 50:1 to 80:1.

BLEACHING AGENT—Especially when the composition is a coulour-care composition, the composition may comprises less than 1%, even more preferably less than 0.1%, and preferably does not contain bleaching agents. The composition may comprise no bleach and/or no bleach activator and/or no photobleach. However, the compositions of the present invention may comprise one or more bleaching agents. In general, when a bleaching agent is used, the compositions of the present invention may comprise from about 0.1% to about 50% or even from about 0.1% to about 25% bleaching agent by weight of the subject detergent composition. When present, suitable bleaching agents include bleaching catalysts, photobleaches for example Vitamin K3 and zinc or aluminium phtalocyanine sulfonate; bleach activators such as tetraacetyl ethylene diamine (TAED) and nonanoyloxybenzene sulphonate (NOBS); hydrogen peroxide; pre-formed peracids; sources of hydrogen peroxide such as inorganic perhydrate salts, including alkali metal salts such as sodium salts of perborate (usually mono- or tetra-hydrate), percarbonate, persulphate, perphosphate, persilicate salts and mixtures thereof, optionally coated, suitable coatings including inorganic salts such as alkali metal; and mixtures thereof.

The amounts of hydrogen peroxide source and peracid or bleach activator may be selected such that the molar ratio of available oxygen (from the peroxide source) to peracid is from 1:1 to 35:1, or even 2:1 to 10:1

FLUORESCENT WHITENING AGENT—Especially when the composition is a coulour-care composition, the composition may not contain components that may tint articles being cleaned, such as fluorescent whitening agent. However, if present, any fluorescent whitening agent suitable for use in a laundry detergent composition may be used in the composition of the present invention. The most commonly used fluorescent whitening agents are those belonging to the classes of diaminostilbene-sulphonic acid derivatives, diarylpyrazoline derivatives and bisphenyl-distyryl derivatives.

Preferred fluorescent whitening agents are Parawhite KX, supplied by Paramount Minerals and Chemicals, Mumbai, India; Tinopal® DMS and Tinopal® CBS available from Ciba-Geigy AG, Basel, Switzerland. Tinopal® DMS is the disodium salt of 4,4′-bis-(2-morpholino-4 anilino-s-triazin-6-ylamino) stilbene disulphonate. Tinopal® CBS is the disodium salt of 2,2′-bis-(phenyl-styryl)disulphonate.

FABRIC HUEING AGENTS—dyes or pigments which when formulated in detergent compositions can deposit onto a fabric when said fabric is contacted with a wash liquor comprising said detergent compositions thus altering the tint of said fabric through absorption of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof.

POLYMERIC DISPERSING AGENTS—The compositions of the present invention can also contain Polymeric dispersing agents. Preferably, when the composition comprises clay, the composition does not comprise polymeric dispersing agent(s). Suitable polymeric dispersing agents, include polymeric polycarboxylates, substituted (including quarternized and oxidized) polyamine polymers, and polyethylene glycols, such as: acrylic acid-based polymers having an average molecular of about 2,000 to about 10,000; acrylic/maleic-based copolymers having an average molecular weight of about 2,000 to about 100,000 and a ratio of acrylate to maleate segments of from about 30:1 to about 1:1; maleic/acrylic/vinyl alcohol terpolymers; polyethylene glycol (PEG) having a molecular weight of about 500 to about 100,000, preferably from about 1,000 to about 50,000, more preferably from about 1,500 to about 10,000; polyaspartate and polyglutamate; carboxymethylcellulose (CMC) materials; and water soluble or dispersible alkoxylated polyalkyleneamine materials. These polymeric dispersing agents, if included, are typically at levels up to about 5%, preferably from about 0.2% to about 2.5%, more preferably from about 0.5% to about 1.5%.

POLYMERIC SOIL RELEASE AGENT—The compositions of the present invention can also contain Polymeric soil release agent. Polymeric soil release agent, or “SRA”, have hydrophilic segments to hydrophilize the surface of hydrophobic fibers such as polyester and nylon, and hydrophobic segments to deposit upon hydrophobic fibers and remain adhered thereto through completion of washing and rinsing cycles, thereby serving as an anchor for the hydrophilic segments. This can enable stains occurring subsequent to treatment with the SRA to be more easily cleaned in later washing procedures. Preferred SRA's include oligomeric terephthalate esters; sulfonated product of a substantially linear ester oligomer comprised of an oligomeric ester backbone of terephthaloyl and oxyalkyleneoxy repeat units and allyl-derived sulfonated terminal moieties covalently attached to the backbone; nonionic end-capped 1,2-propylene/polyoxyethylene terephthalate polyesters; an oligomer having empirical formula (CAP)₂ (EG/PG)₅ (T)₅ (SIP)₁ which comprises terephthaloyl (T), sulfoisophthaloyl (SIP), oxyethyleneoxy and oxy-1,2-propylene (EG/PG) units and which is preferably terminated with end-caps (CAP), preferably modified isethionates, as in an oligomer comprising one sulfoisophthaloyl unit, 5 terephthaloyl units, oxyethyleneoxy and oxy-1,2-propyleneoxy units in a defined ratio, preferably about 0.5:1 to about 10:1, and two-end-cap units derived from sodium 2-(2-hydroxyethoxy)-ethanesulfonate; oligomeric esters comprising: (1) a backbone comprising (a) at least one unit selected from the group consisting of dihydroxy sulfonates, polyhydroxy sulfonates, a unit which is at least trifunctional whereby ester linkages are formed resulting in a branched oligomer backbone, and combinations thereof; (b) at least one unit which is a terephthaloyl moiety; and (c) at least one unsulfonated unit which is a 1,2-oxyalkyleneoxy moiety; and (2) one or more capping units selected from nonionic capping units, anionic capping units such as alkoxylated, preferably ethoxylated, isethionates, alkoxylated propanesulfonates, alkoxylated propanedisulfonates, alkoxylated phenolsulfonates, sulfoaroyl derivatives and mixtures thereof. Preferred are esters of the empirical formula:

((CAP)ₐ (EG/PG)_{b} (DEG)_{c} PEG)_{d} (T)ₑ (SIP)_{f} (SEG)_{g} (B)ₕ)

wherein CAP, EG/PG, PEG, T and SIP are as defined hereinabove, DEG represents di(oxyethylene)oxy units, SEG represents units derived from the sulfoethyl ether of glycerin and related moiety units, B represents branching units which are at least trifunctional whereby ester linkages are formed resulting in a branched oligomer backbone, a is from about 1 to about 12, b is from about 0.5 to about 25, c is from 0 to about 12, d is from 0 to about 10, b+c+d totals from about 0.5 to about 25, e is from about 1.5 to about 25, f is from 0 to about 12; e+f totals from about 1.5 to about 25, g is from about 0.05 to about 12; h is from about 0.01 to about 10, and a, b, c, d, e, f, g, and h represent the average number of moles of the corresponding units per mole of the ester; and the ester has a molecular weight ranging from about 500 to about 5,000.; and; cellulosic derivatives such as the hydroxyether cellulosic polymers available as METHOCEL® from Dow; the C₁-C₄ alkyl celluloses and C₄ hydroxyalkyl celluloses, see U.S. Pat. No. 4,000,093, issued Dec. 28, 1976 to Nicol et al., and the methyl cellulose ethers having an average degree of substitution (methyl) per anhydroglucose unit from about 1.6 to about 2.3 and a solution viscosity of from about 80 to about 120 centipoise measured at 20° C. as a 2% aqueous solution. Such materials are available as METOLOSE SM100® and METOLOSE SM200®, which are the trade names of methyl cellulose ethers manufactured by Shinetsu Kagaku Kogyo KK.

ENZYMES—The compositions can comprise one or more enzymes which provide cleaning performance and/or fabric care benefits. Examples of suitable enzymes include, but are not limited to, hemicellulases, peroxidases, proteases, other cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. In a preferred embodiment, the compositions of the present invention will further comprise a lipase, for further improved cleaning and whitening performance. A typical combination is an enzyme cocktail that may comprise, for example, a protease and lipase in conjunction with amylase. When present in the detergent composition, the aforementioned enzymes may be present at levels from about 0.00001% to about 2%, from about 0.0001% to about 1% or even from about 0.001% to about 0.5% enzyme protein by weight of the composition.

ENZYME STABILIZERS—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

CATALYTIC METAL COMPLEXES—The compositions of the invention preferably do not comprise catalytic metal complexes. However, when present, one type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464.

SOLVENTS—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof. The composition may comprise at most 20%, especially at most 5% of water.

SOFTENING SYSTEM—the compositions of the invention may comprise a softening agent and optionally also with flocculants and enzymes; optionally for softening through the wash.

FABRIC SOFTENING BOOSTING COMPONENT—Typically, the composition additionally comprises a charged polymeric fabric-softening boosting component. When the composition comprises clay and silicone particles, preferably, the charged polymeric fabric-softening boosting component is contacted to the clay and silicone in step (ii) of the process for obtaining clay and silicone particles (see above). The intimate mixing of the charged polymeric fabric-softening boosting component with the clay and silicone further improves the fabric-softening performance of the resultant composition.

COLORANT—the compositions of the invention may comprise a colorant, preferably a dye or a pigment. Particularly, preferred dyes are those which are destroyed by oxidation during a laundry wash cycle. To ensure that the dye does not decompose during storage it is preferable for the dye to be stable at temperatures up to 40° C. The stability of the dye in the composition can be increased by ensuring that the water content of the composition is as low as possible. If possible, the dyes or pigments should not bind to or react with textile fibres. If the colorant does react with textile fibres, the colour imparted to the textiles should be destroyed by reaction with the oxidants present in laundry wash liquor. This is to avoid coloration of the textiles, especially over several washes. Particularly, preferred dyes include but are not limited to Basacid® Green 970 from BASF and Monastral blue from Albion.

### Laundry Detergent Composition

The composition is preferably a laundry detergent composition, for example a colour care composition and/or a fabric care composition.

The composition is for example in particulate form, preferably in free-flowing particulate form, although the composition may be in any liquid or solid form. The composition in solid form can be in the form of an agglomerate, granule, flake, extrudate, bar, tablet or any combination thereof. The solid composition can be made by methods such as dry-mixing, agglomerating, compaction, spray drying, pan-granulation, spheronization or any combination thereof. The solid composition preferably has a bulk density of from 300 g/l to 1,500 g/l, preferably from 500 g/l to 1,000 g/l.

The composition may also be in the form of a liquid, gel, paste, dispersion, preferably a colloidal dispersion or any combination thereof. Liquid compositions typically have a viscosity of from 500 cps to 3,000 cps, when measured at a shear rate of 20 s⁻¹ at ambient conditions (20° C. and 1 atmosphere), and typically have a density of from 800 g/l to 1300 g/l. If the composition is in the form of a dispersion, then it will typically have a volume average particle size of from 1 micrometer to 5,000 micrometers, preferably from 1 micrometer to 50 micrometers. The particles that form the dispersion are usually the clay and, if present, the silicone. Typically, a Coulter Multisizer is used to measure the volume average particle size of a dispersion.

The composition may in unit dose form, including not only tablets, but also unit dose pouches wherein the composition is at least partially enclosed, preferably completely enclosed, by a film such as a polyvinyl alcohol film.

The colour care composition may also be capable of both cleaning and softening fabric during a laundering process. Typically, the composition is formulated for use in an automatic washing machine, although it can also be formulated for hand-washing use.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

The following examples are given by way of illustration only and therefore should not be construed to limit the scope of the invention.

### EXAMPLES

In the exemplified compositions, the concentrations of the components are in weight percentage and the abbreviated component identifications have the following meanings:
C45AE7S=average C₁₄-C₁₅ linear alcohol ethoxylate condensed with an average of 7 moles of ethylene oxide per mole of alkyl alcohol
DHLAC=dimethyl hydroxyethyl lauryl ammonium chloride;
LAS=linear alkylbenzene sulfonate;
DTPA=diethylene triamine penta acetate
p(AA/MA)=acrylic acid/maleic acid copolymer
PDMS=Polydimethylsiloxane
p(ethylene oxide)=High molecular weight poly(ethyleneoxide)
PVNO=poly 4-vinylpyridine N-oxide
PVPVI=poly(N-vinyl-2-pyrrolidone)-poly(N-vinyl-imidazol)

| | | Example 1 | Example 2 | Example 3 |
|---|---|---|---|---|
| Constituent Name: | | (comparative) | (comparative) | (invention) |
| Surfactant | C45AE7 | 1.65 | 1.65 | 1.65 |
| | DHLAC | 0.75 | 0.75 | 0.75 |
| | LAS | 12.04 | 12.82 | 12.82 |
| Builders | Citric Acid | 1.45 | 1.45 | 1.45 |
| | Phosphate | 22.21 | 22.21 | 22.21 |
| | SiO₂/Na₂O ratio 1:6 | 6.98 | 6.98 | 1.98 |
| | SiO₂/Na₂O ratio 2:0 | 1.023 | 1.023 | 1.023 |
| | Zeolite A | 2.88 | 2.88 | 2.88 |
| Buffer | Na₂CO₃ | 16.05 | 14.05 | 15.05 |
| | NaOH | 0.0077 | 0.0077 | 0.0077 |
| Chelant | DTPA (Na) | 0.68 | 0.68 | 0.68 |
| Enzymes | | 0.49 | 0.49 | 0.49 |
| Polymers | p(AA/MA) | 4.30 | 4.30 | 4.30 |
| Suds Control | Silicone antifoam | 0.06 | 0.056 | 0.056 |
| clay/silicone | PDMS | | 1.43 | 1.43 |
| particles | Bentonite Clay | | 4.87 | 4.87 |
| | LAS | | 0.22 | 0.22 |
| | Water | | 0.26 | 0.26 |
| | miscellaneous | | 0.014 | 0.014 |
| flocculating | p(ethylene oxide) | | 0.13 | 0.13 |
| aid | | | | |
| Dye transfer | PVNO | 0.24 | | 0.24 |
| inhibitor | PVPVI | 0.24 | | 0.24 |
| Filler | Na2SO4 | 22.64 | 17.41 | 20.93 |

| | | | |
|---|---|---|---|
| Miscellaneous and water | bal to 100.00 | bal to 100.00 | bal to 100.00 |

The clay/silicone particles are obtained according to the process disclosed in example 2 of EP 1 561 806.

The compositions of the examples are formulated as follow. LAS, DHLAC, the phosphate builders, the buffers, the chelant, and the flocculating aid are mixed in a crutcher to obtain a blown powder. Afterwards, this blown powder is admixed with the other builders (citric acid, silicates, zeolite), the enzymes, the polymers, the suds control, the clay/silicone particles, the polymeric dye transfer inhibitor, and the filler. Finally, the C45AE7 is sprayed on the particles.

Coloured fabrics are washed at 40° C., in hard water (more than 15 gpg) with one of the composition of the examples above. The fabrics are then visually compared by a panel of expert.

After one and after five cycles, coloured fabrics washed with the composition of example 3 are showing more vibrant colours than the fabrics washed with the composition of the comparative examples 1 and 2.

White fabrics washed with any of composition of examples 1 to 3 are showing a similar whiteness.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A colour-care composition comprising:
(a) from 0.1% to 30% by weight of the composition of a dye transfer inhibitor chosen from polyvinylpyrrolidone, poly(4-vinylpyridine N-oxide), copolymer of polyvinylpyrrolidone and polyvimyilimidazole, and mixtures thereof;
(b) from 1% to about 30% by weight of the composition of a silicone;
(c) from 0.3% to 30% by weight of the composition of a clay;

2. The composition of claim 1, wherein the composition further comprises 1% to 50% by weight of the composition of an anionic surfactant; and wherein the average molecular weight of the dye transfer inhibitor of claim 1 is from 2,000 to 100,000.

3. The composition of claim 2, wherein the dye transfer inhibitor comprises polyvinylpyrrolidone.

4. The composition of claim 2, wherein the dye transfer inhibitor comprises, poly(4-vinylpyridine N-oxide).

5. The composition of claim 2, wherein the dye transfer inhibitor comprises copolymer of polyvinylpyrrolidone and polyvimyilimidazole.

6. The composition of claim 2, wherein the composition if free of a bleaching agent

7. The composition of claim 6, wherein the composition is free of a cationic detersive surfactant.

8. The composition of claim 2, wherein the composition comprises from 1.1% to 4.9% of the silicone; and from 3% to 10% of the clay.

9. The composition of claim 8, wherein the composition comprises is free of a bleaching agent and is free of a cationic detersive surfactant.

10. The composition of claim 8, further comprising a 3% to 15% by weight of the composition of a builder comprising Na₂CO₃ and NaOH.

11. The composition of claim 9, further comprising a 3% to 15% by weight of the composition of a builder comprising Na₂CO₃ and NaOH.

12. The composition of claim 9, where the composition comprises at most 5% by weight of the composition of an aminosilicate(s) and/or phosphate builder(s).

13. The composition of claim 2, where the composition comprises at most 5% by weight of the composition of an aminosilicate(s) and/or phosphate builder(s).

14. A method of treating laundry comprising the step of adding the composition of claim 1 to a fabric treatment solution.
